(19) United States
(12) Patent Application Publication
(10) Pub. No.: US 2010/0075646 A1
(43) Pub. Date: Mar. 25, 2010

(54) METHOD FOR TERMINATING TO A MOBILE NETWORK A CALL DIRECTED TO A FIXED NETWORK NUMBER

(75) Inventors: Massimo Giambone, Ivrea (IT); Renato Malesan, Ivrea (IT); Mirco Zublena, Ivrea (IT)

Correspondence Address: Workman Nydegger;1000 Eagle Gate Tower, 60 East South Temple, Salt Lake City, UT, 84111, US

(73) Assignees: VODAFONE OMNITEL N.V., Amsterdam (NL); VODAFONE GROUP PLC, Newbury, Berkshire (GB)

(21) Appl. No.: 12/447,442

(22) PCT Filed: Oct. 23, 2007
(86) PCT No.: PCT/IB2007/003173

§ 371 Date: Apr. 27, 2009

(30) Foreign Application Priority Data
Oct. 27, 2006 (IT) MI2006A002071

(51) Int. Cl. H04W 4/00

(52) U.S. Cl. 455/417

(57) ABSTRACT

The invention relates to a method for terminating a call coming from a calling party (A) and directed to a fixed network number being called, associated with a telecommunications network (1) comprising a mobile network (2). The method includes the steps of receiving the call at an access node to the telecommunications network (1), obtaining one or more mobile network numbers belonging to the mobile network (2) and associated with the fixed network number being called, and terminating the call to such mobile network numbers. Termination is based on the geographic location of the mobile terminals of the mobile network.

The present invention relates to a method for terminating a call directed to a fixed network number to a mobile network.

A call forwarding system is known in the art, for forwarding calls directed to fixed network terminals to other fixed or mobile network terminals.

Call forwarding is made available by the fixed network telephone operator of the user and allows the calls directed to the fixed network number of the user to be routed to another fixed network number, possibly belonging to another fixed network operator, or to a mobile network number, if the user uses a mobile terminal.

Such call forwarding operation is performed by the fixed network telephone company at the telephone exchange of the fixed network and can be performed for any call directed to the fixed network number or, if the user doesn't answer, e.g. after a certain number of rings to the fixed network terminal of the user.

This call forwarding method for calls directed to fixed network numbers still suffers from a number of drawbacks.

First, the user is required to be able to use a fixed network line, and hence to subscribe a contract with the fixed network telephone company.

Furthermore, the costs for such call forwarding service are charged to the called user, because the call is handled as a new call from the fixed terminal forwarding to the mobile terminal of the user being called.

Therefore, there arises the need of terminating a call directed to a fixed network number to a mobile network number without requiring the user to use a fixed network line.

Therefore, the object if this invention is to provide a method for terminating a call directed to a fixed network number to a mobile network number, that has such features as to fulfill the above needs, while obviating the drawbacks of prior art.

This object is fulfilled by a method for terminating a call directed to a fixed network number as defined in claim 1.

In another aspect, this object is fulfilled by a telecommunications network as defined in claim 13.

Further features and advantages of the method and network of this invention, will be apparent from the following description of one preferred embodiment thereof, which is given by way of illustration and without limitation with reference to the accompanying figures, in which:

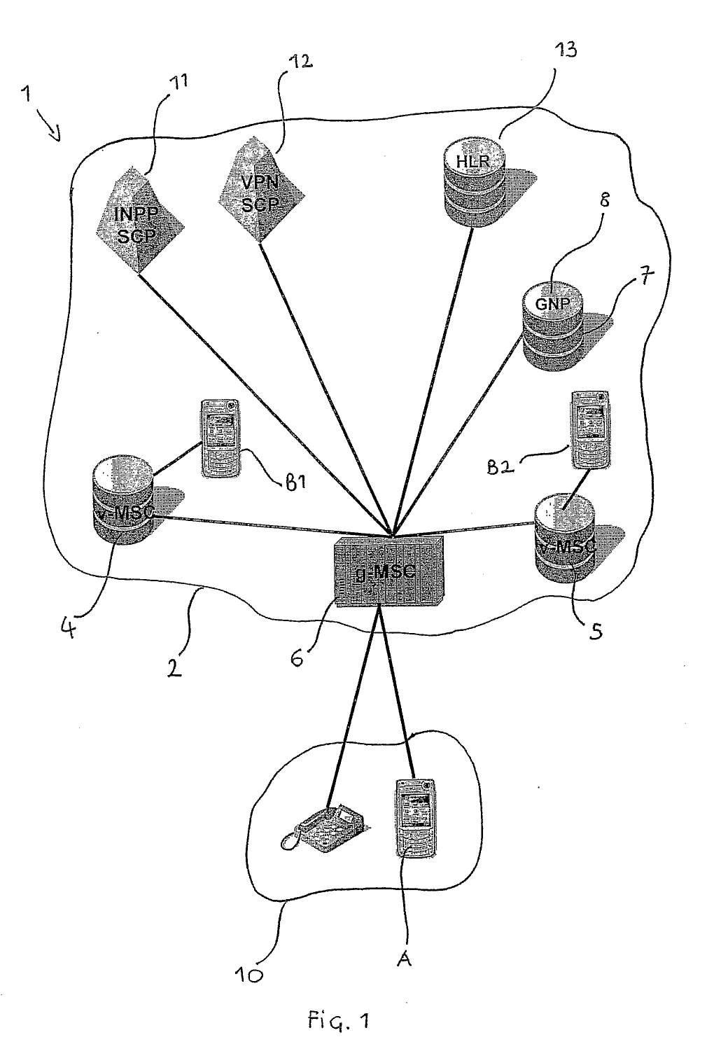

FIG. 1 is a schematic view of a telecommunications network of this invention,

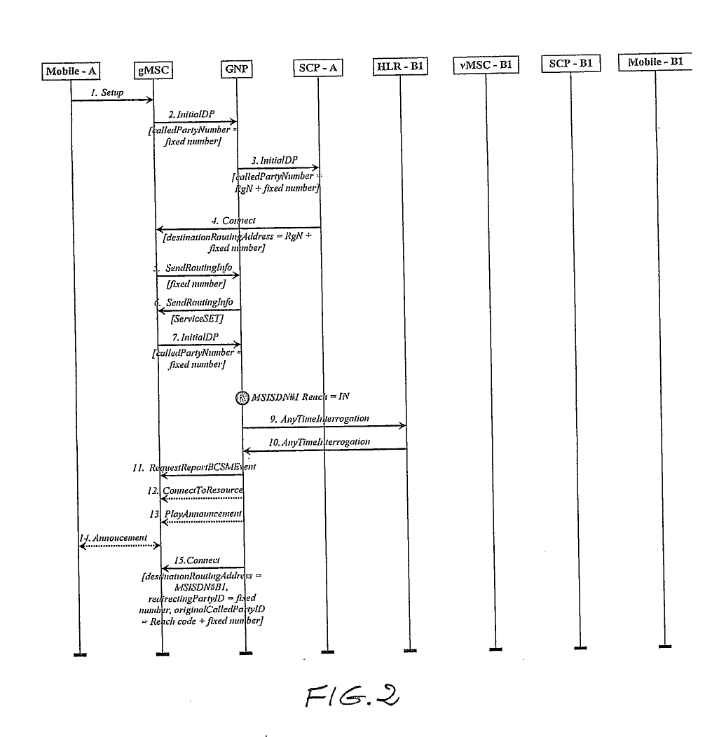

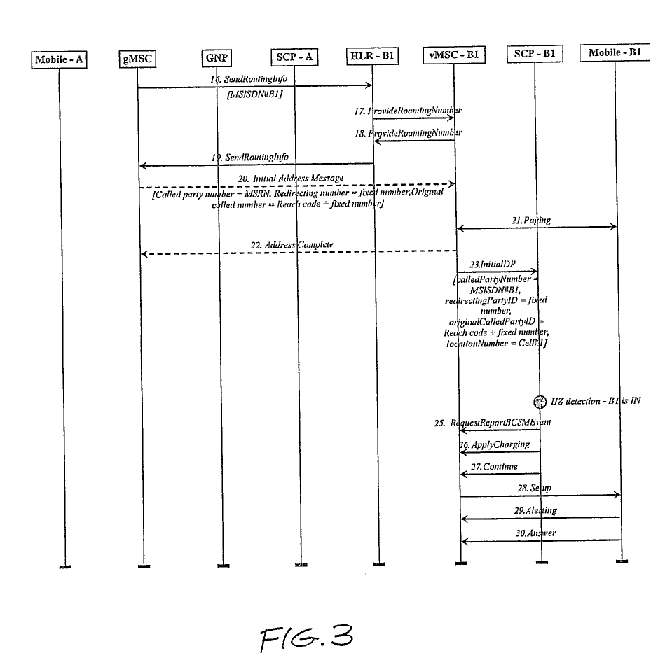

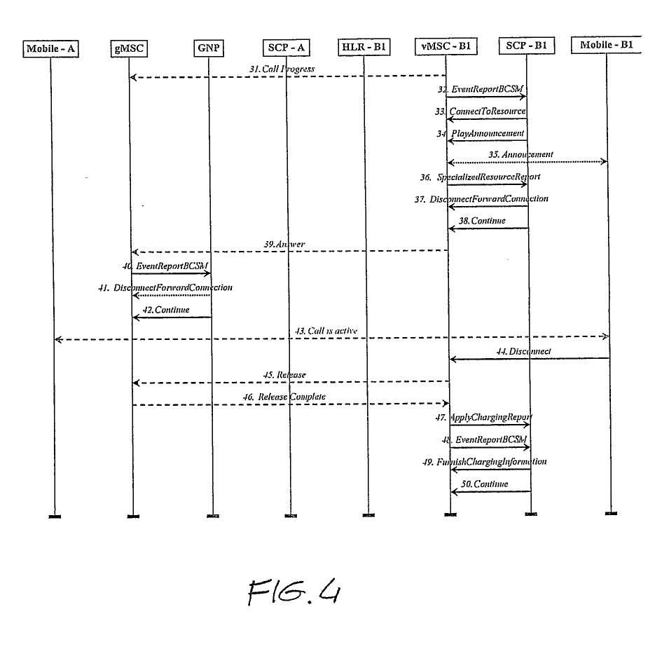

FIGS. 2 to 4 show an example of message flow in the network of FIG. 1 according to the method for terminating a call to a fixed network number of this invention.

Referring to FIG. 1, a telecommunications network is generally designated with numeral 1.

The telecommunications network 1 comprises a mobile network 2 adapted to serve a plurality of mobile users.

The telecommunications network 1 is also associated with fixed network telephone numbers. Thus the telecommunications network 1 lacks of fixed network and the fixed network numbers are simply addressed to such telecommunications network 1.

The mobile network 2 is designed to serve mobile users, identified by respective mobile network telephone numbers, and is commonly known as a Public Land Mobile Network (PLMN).

A typical PLMN mobile network comprises a plurality of communication nodes, known as Mobile Switching Centers (MSC), in this example the MSCs 4, 5, 6 and a plurality of mobile terminals, in this example the mobile terminals B1, B2.

Each mobile terminal is served by a MSC, which routes all the calls directed to the mobile network number associated with the mobile terminal, to such mobile terminal. In the example as shown in the annexed figures, the mobile terminal B1 is served by the MSC 4, whereas the mobile terminal B2 is served by the MSC 5.

The telecommunications network 1 further comprises an access node 6, able to put an access network 10 in communication with the telecommunications network 1, particularly with the mobile terminals B1, B2 of the mobile network 2. Particularly, the access node 6 is able to receive a call coming from the access network 10 and directed to a fixed network number associated, i.e. assigned to the telecommunications network 1.

The access node 6 is in communication with each MSC of the mobile network 2, in this example the MSCs 4,5, to allow communication between the access network 10 and the mobile terminals B1, B2 served by the mobile network 2.

The access network 10 is either a fixed network, in which case the calling party A is a fixed network telephone terminal, or a mobile network, in which case the calling party A is a mobile network terminal. The mobile access network may also be the mobile network 2 itself.

In accordance with the embodiment as shown in the figures, the access node 6 is a gateway MSC 6 or g-MSC. Particularly, the g-MSC 6 is able to intercept any call from the access network 10, particularly from the calling party A, and directed to a fixed network number belonging to the telecommunications network 1.

The mobile network 2 further comprises a database 7 accessible from the g-MSC 6. This database 7 comprises a plurality of fixed network numbers and at least one mobile network number belonging to the mobile network 2 and associated with each fixed network number of the plurality of fixed network numbers.

In practice, a mobile telephone user of the mobile network 2, subscribing to the service of call termination to the mobile network is assigned a fixed network number whereby he/she can receive calls from access telecommunications networks.

This fixed network number is stored in the database 7 and associated with the mobile network number of the user. Nevertheless, as described in greater detail hereafter, the mobile network user may associate a plurality of mobile network numbers with such fixed network number. In other words, multiple mobile network users can decide to associate their own mobile network numbers with a single fixed network number.

The fixed network number can belong to the mobile network operator, if such mobile network operator is also licensed as a fixed network operator, or led into the network of such operator by other fixed network operators.

The database 7 is stored in a network server 8 with geographic number portability (GNP) features, allowing recognition of the network that owns the fixed network number being called.

The network server 8 can also communicate with the access node 6 to send to the access node 6 the mobile network number associated with the fixed network number provided by the access node 6.

Thus, the access node 6 can route or terminate the call directed to the fixed network number to the mobile network number retrieved from the database 7 of the server 8.

Once the g-MSC 6 receives a call directed to a fixed network number associated with the network 1, it accesses the database 7 of the mobile network 2 to obtain at least one mobile network number associated with such fixed network number being called.

Thus, the g-MSC access node 6 is adapted to receive at least one mobile network number associated with the fixed network number from the database 7 to put the access network 10, i.e. the calling party A, in communication with the mobile terminal associated with the mobile network number, such as the mobile terminal B1 associated with the mobile network number MSISDN-B1 or the mobile terminal B2 associated with the mobile network number MSISDN-B2.

The mobile network 2 further comprises control units, known as signaling control points (SCP), having the function of controlling the calls to the subscribed mobile users in the mobile network 2.

For example, the SCPs may be divided into SCPs for users with prepaid profiles, known as Intelligent Network Prepaid SCPs (INPP SCPs), in the illustrated example the INPP SCP 11, and SCPs for users with postpaid profiles, known as Virtual Private Network SCPs (VPN SCPs), in the illustrated example the VPN SCP 12.

The mobile network 2 further comprises a plurality of user databases, known as Home Location Registers (HLRs), in this example the HLR 13, which store information concerning mobile network telephone users of the network 2.

In the method for terminating a call coming from the calling party A and directed to a fixed network number being called, the call is first received at the access node 6.

Depending on the fixed network number being called, at least one mobile network number associated with such fixed network number being called is obtained, e.g. from the database 7, whereupon the call to the fixed network number can be routed, i.e. terminated to the mobile network number obtained from the database 7.

According to a preferred embodiment, the mobile network number is associated with a reachability identification code able to allow or prevent the connection with the mobile terminal B associated with such mobile network number.

In this case, the method comprises the step of obtaining the reachability identification code of the mobile terminal B from the database 7, for allowing or preventing the connection between the calling party A and the mobile terminal as a function of the reachability identification code obtained from the database 7.

In accordance with the method, each fixed network number in the database 7 is associated with a coverage area, named home area.

Then, the method comprises the steps of obtaining, from the SCP of the terminal B, the identification code of the home area of the fixed network number being called and of detecting the position of the mobile terminal associated with the mobile network number associated therewith to obtain a position identification code of the mobile terminal.

In this case, the predetermined position code is a code that identifies the mobile radio cell serving the coverage area of the fixed network number being called and the detected position code is a code that identifies the mobile radio cell in which the mobile terminal associated with the mobile network number is registered.

In other words, the home area is a set of mobile radio cells serving the coverage area of the fixed network number being called and the detected position code is a code identifying the radio mobile cell in which the mobile terminal associated with the mobile network number is registered.

The comparison of the position identification code of the fixed network number, i.e. the home area, with the position identification code of the mobile terminal provides grounds to decide whether the connection with the mobile terminal has to be established and which rate has to be applied to such connection.

Particularly, by this comparison, the signaling control node SCP of the mobile network 2 can be presented with data representative of such comparison to determine the call rate, and thence establish connection between the calling party A and the mobile terminal B based on such rate.

Particularly, if the home area matches the position identification code of the mobile terminal, then the mobile terminal is in the coverage area of the fixed network number, i.e. the home area. In this case, the mobile terminal of the user acts as a fixed network terminal, and a zero rate will be typically applied to the incoming call. However, the rate applied to this case can also be other than zero depending on the type of contract that the user has subscribed with the network that owns the mobile network 2.

If the home area does not match the position identification code of the mobile terminal, then the mobile terminal is out of the coverage area of the fixed network number, i.e. out of the home area. In this case, the mobile terminal of the user acts as a mobile terminal proper, and a rate will be typically applied to the call by the operator, depending on the specifications of the contract subscribed by the user. Otherwise, the connection between the calling party A and the mobile terminal B can be prevented, based on terms selected by the user beforehand.

Therefore, termination is found to be based on the geographic location of the mobile terminals of the mobile network 2.

As mentioned above, the fixed network number may be associated with a plurality of mobile network numbers.

In this case, the individual mobile network numbers are successively detected until a connection between the calling party A and a mobile terminal B is established.

Essentially, one fixed network number may be associated with a list of mobile network user numbers. Each mobile user in the list may be reached by dialing the fixed network number in accordance with user-selected reachability and mobile terminal position terms.

An example of the method of the present invention is described below, in which a mobile terminal A makes a call to a fixed network number assigned to the telecommunications network 1.

The g-MSC 6 intercepts the call to the fixed network number (Step 1) and transmits the fixed network telephone number being called to the GNP node 8 (Step 2).

The GNP node 8 recognizes the network that owns the fixed network number being called, in this example the mobile network 2, adds a special prefix RgN to such called number and communicates with the SCP-A node for billing operations, depending on the type of calling party A, in this example a mobile terminal (Step 3).

The SCP-A asks the g-MSC 6 to route the call to the network that owns the fixed network number being called (Step 4).

Since the special prefix RgN indicates that the fixed network number belongs to the network 1, the call may be routed, i.e. terminated to the mobile telephone number associated with the fixed network number being called. Then, the g-MSC 6 contacts the GNP 8 to notify that a call termination procedure can be initiated to terminate the call to a mobile network number (Step 5).

The node GNP 8 replies to the g-MSC 6 acting as a HLR and transmits termination information to the g-MSC 6 (Step 6).

The information received from the GNP 8 indicates that the g-MSC 6 has to communicate with the GNP 8 to terminate the call from the fixed network number being called to the mobile network number MSISDN-B1 associated therewith and stored in the database 7 of the GNP node 8, corresponding to the mobile terminal B1 (Step 7).

The GNP node 8 checks the reachability identification code REACH of the mobile telephone B1, i.e. the mobile network number MSISDN-B1 of the mobile phone B1, to control the SCP-B1 to establish a connection with the mobile terminal B1 or prevent connection with the mobile terminal B1 (Step 8).

The reachability identification code REACH may be IN, ALWAYS, NEVER.

If the identification code REACH=IN, then the connection with the mobile terminal B1 will be only established if the mobile terminal B1 is within the home area.

If the identification code REACH=ALWAYS, then the connection with the mobile terminal B1 will be established even when the mobile terminal B1 is outside the home area.

If the identification code REACH=NEVER, then the connection with the mobile terminal B1 will not be established because the customer has temporarily disabled the service.

In the illustrated case, REACH=IN and connection can be only established if the mobile terminal is within the home area.

Then, the GNP node 8 contacts the HLR-B1 of the mobile terminal B1 (Step 9) to check that the mobile terminal B1 is in the Home PLMN. The HLR-B1 replies to the GNP 8 and indicates whether the connection with the mobile terminal B1 is allowed or prevented depending on the presence or absence of the mobile terminal B1 in the home PLMN (Step 10).

If the reply of the HLR-B1 requires the connection to be prevented, there are two options: either the call is released or, if the fixed network number being called is associated with multiple mobile network numbers, the method is repeated from Step 8 for the second mobile network number MSISDN-B2 of the mobile terminal B2 in the list of the mobile network numbers associated with the fixed network number being called, and so forth for the other mobile network numbers until a mobile terminal is connected to the mobile terminal A.

In Step 11, the GNP 8 can request notification of the call process to continue or stop the search for mobile network telephone numbers until a mobile terminal answers.

The Steps 12, 13, 14 involve the possibility of playing courtesy sounds or tones to the calling terminal A.

Then the GNP node 8 transmits the termination address, i.e. the mobile network number MSISND-B1, to the g-MSC 6, for initiating the connection procedure (Step 15).

Now, the g-MSC 6 attempts connection with the mobile terminal B1 by typical routing to the mobile network number MSISDN-B1 of the mobile terminal B1 (Steps 16-22), while involving the vMSC-B1 that serves the mobile terminal B1.

The vMSC-Bl contacts the SCP-B1 in which the home area of the fixed network number being called is stored, and provides to the SCP-B1 the mobile network number MSISDN-B1 and the position identification code of the mobile terminal B1, i.e. the code of the cell in which the mobile terminal B1 is registered (Step 23).

Based on such data, the SCP-B1 can check if the home area matches the position identification code of the mobile terminal (Step 24).

If the SCP-B1 ascertains that the mobile terminal B1 is outside the home area, the call is rejected because the reachability identification code REACH of the mobile terminal is IN. If the reachability identification code REACH of the mobile terminal were ALWAYS, then connection would be established between the mobile terminal A and the mobile terminal B1.

If the SCP-B1 ascertains that the terminal B1 is within the home area, then connection is established between the mobile terminal A and the mobile terminal B1.

The next Steps 25 to 50 are typical communication steps involving two mobile terminals, which are known per se and will not be described in detail herein.

As clearly shown in the above description, the method of the present invention fulfills the needs and obviates the prior art drawbacks as set out in the introductory part of this disclosure.

Particularly, the method of the invention allows termination of a call directed to a fixed network number being called to a mobile network number without requiring the user that owns such fixed network number to have a fixed network terminal and hence without requiring the user to subscribe a contract with a fixed network operator in addition to the contract with the mobile network operator.

Furthermore, the comparison of the home area associated with the fixed network number being called with the position identification code of the mobile network number whereto the call is terminated provides information as to whether the mobile terminal is within the home area or outside it, for differential billing.

Those skilled in the art will obviously appreciate that a number of changes and variants may be made to the method and telecommunications network if the invention as described hereinbefore to meet specific needs, without departure from the scope of the invention, as defined in the following claims.

1. A method for terminating a call coming from a calling party belonging to an access network and directed to a fixed network called number, said fixed network called number being assigned to a telecommunications network comprising a mobile network and lacking of a fixed network, said method comprising the steps of:
receiving said call at an access node able to put said access network in communication with said telecommunications network,
obtaining at least one mobile network number belonging to said mobile network and associated with said fixed network called number,
terminating said call towards said at least one mobile network number.

2. The method in accordance with claim 1, wherein said step of obtaining said at least one mobile network number comprises the step of accessing a database of said mobile network to obtain said at least one mobile network number.

3. The method in accordance with claim 1, wherein said step of receiving said call comprises the step of receiving and stopping said call at said access node.

4. The method in accordance with claim 1, wherein said at least one mobile network number is associated with predefined reachability rules, said method further comprising the step of establishing or preventing a connection between said calling party and the mobile terminal addressed by said at least one mobile network number as a function of said reachability rules.

5. The method in accordance to claim 4, wherein said reachability rules comprise rules related to the geographic position of said mobile terminal.

6. The method in accordance with claim 1, wherein said at least one mobile network number is associated with a reachability identification code able to allow or prevent the connection with the mobile terminal associated with said at least one mobile network number, said method further comprising the steps of:
obtaining the reachability identification code of the mobile terminal,
allowing or preventing the connection between said calling party and said mobile terminal (B) as a function of said reachability identification code.

7. The method in accordance with claim 1, further comprising the steps of:
obtaining an position identification code of the fixed network called number, detecting the position of the mobile terminal associated with said at least one mobile network number to obtain a position identification code of the mobile terminal,
comparing the position identification code of the fixed network number with the position identification code of the mobile terminal.

8. The method in accordance with claim 1, further comprising the steps of:
obtaining the home area of the fixed network called number,
detecting the position of the mobile terminal associated with said at least one mobile network number to obtain a position identification code of the mobile terminal,
comparing the home area with the position identification code of the mobile terminal.

9. The method in accordance with claim 8, wherein said fixed network called number is associated with a predefined coverage area, said home area being a set of mobile radio cells serving said predefined coverage area of the fixed network called number and said detected position identification code being a code identifying the radio mobile cell where said mobile terminal is registered.

10. The method in accordance with claim 7, further comprising the steps of:
providing a data representative of the comparing step to a signalling control node of said mobile network to identify a call rate,
establishing a connection between said calling party and said mobile terminal on the basis of said call rate.

11. The method in accordance with claim 7, wherein said comparing step is negative, said method further comprising the step of preventing the connection between said calling party and said mobile terminal.

12. The method in accordance with claim 1, wherein said fixed network called number is associated with a plurality of mobile network numbers, said steps of obtaining at least one mobile network number and terminating said call being performed sequentially for each mobile network number of said plurality of mobile network numbers until a connection is established between said calling party and a mobile terminal.

13. A telecommunication network comprising:
a mobile network and lacking of a fixed network, said mobile network comprising a plurality of mobile terminals and an access node able to put an access network in communication with said telecommunications network,
wherein said access node is able to receive a call coming from said access network and directed to a fixed network number assigned to said telecommunications network, and
wherein said mobile network comprises a database accessible from said access node, said database comprising a plurality of fixed network numbers and at least one mobile network number belonging to said mobile network and associated to each fixed network number of said plurality of fixed network numbers, said access node being able to terminate said call towards said at least one mobile network.

14. The telecommunications network in accordance with claim 13, further comprising a plurality of mobile switching centers, each switching center of said plurality of switching centers serving a plurality of mobile terminals and being in communication with said access node of said telecommunications network.

15. The telecommunications network in accordance with claim 13, further comprising a network server having storage means for storing said database, said network server being adapted to communicate with said access node to send, to said access node, said at least one mobile network number associated with the fixed network call number.
